(19) United States
(12) Patent Application Publication
(10) Pub. No.: US 2026/0310781 A1
(43) Pub. Date: Oct. 8, 2026

(54) APPARATUS FOR GATEWAY, CONTROL METHOD THEREOF AND VEHICLE SYSTEM

(71) Applicants: Hyundai Motor Company, Seoul (KR); Kia Corporation, Seoul (KR); KOOKMIN UNIVERSITY INDUSTRY-ACADEMIC COOPERATION FOUNDATION, Seoul (KR)

(72) Inventors: Jang Ho SHIN, Hwaseong-Si (KR); Ho KANG, Seoul (KR); Sol AHN, Seoul (KR); Won Seok SONG, Seoul (KR); Jong Chan KIM, Seoul (KR); Chang Jo CHO, Seoul (KR)

(21) Appl. No.: 19/363,156

(22) Filed: Oct. 20, 2025

(30) Foreign Application Priority Data
Apr. 8, 2025 (KR) 10-2025-0045344

(51) Int. Cl. G06F 21/44; H04L 9/40

(52) U.S. Cl. CPC G06F 21/44; H04L 63/0281

(57) ABSTRACT

Described herein is a gateway in a vehicle system, a method of controlling data flow by the gateway device. The gateway device is configured to execute a protection algorithm for a Type of Service (ToS) value of a socket corresponding to an application, perform authentication of the application using a secure world, dispose or insert data of the application in one of security bands and general bands of transmit queues, and depending on an authentication result of the application, transmit data of the application through an activated band among the security bands and the general bands.

### CROSS-REFERENCE TO RELATED APPLICATIONS

This application claims the benefit of priority to Korean Patent Application No. 10-2025-0045344 filed on Apr. 8, 2025, in the Korean Intellectual Property Office, the disclosure of which is incorporated herein by reference in its entirety.

### BACKGROUND

### 1. Field

The present disclosure relates to an apparatus for a gateway in a vehicle system, and/or a control method of the gateway in the vehicle system.

### 2. Description of Related Art

The matters described in this Background section are only for the enhancement of understanding of the background of the disclosure, and should not be taken as an acknowledgement that they correspond to prior art already known to those skilled in the art.

As the electrification of components for a vehicle progresses rapidly, the types and number of electronic devices installed in the vehicle are increasing significantly. An electronic device may be broadly used in a power train control system, a body control system, a chassis control system, a vehicle network multimedia system, and the like.

Electronic devices in a vehicle may be connected via a vehicle network. In general, the vehicle network may include various heterogeneous communication networks such as Controller Area Network (CAN), Controller Area Network with Flexible Data-rate (CAN FD), Local Interconnect Network (LIN), FlexRay, Media Oriented Systems Transport (MOST), Ethernet, and the like.

In an Ethernet-based vehicle network communication, a security method may be needed to protect the reliability and stability of the network from attacks by malicious applications.

### SUMMARY

Aspects of the present disclosure describe an apparatus that may be used as a gateway in a vehicle system, and/or a control method of the gateway. The gateway described herein may enhance the security and stability of an Ethernet-based in-vehicle communication.

Aspects of the present disclosure describe an apparatus for a gateway in a vehicle system, and/or a control method of the gateway. The gateway described herein may prevent a malicious application from accessing a ToS (Type of Service) value of a socket of the vehicle system and interfering with other data transmissions of other applications.

Aspects of the present disclosure describe an apparatus for a gateway in a vehicle system and/or a control method of the gateway. The gateway may control a flow of data in the vehicle system so that only an authenticated application may transmit data in a limitedly accessible secure world.

Aspects of the present disclosure describe an apparatus for a gateway in a vehicular system. The apparatus for the gateway may include: a processor, and a storage medium storing commands executable by the processor, wherein, by executing the commands, the processor may be configured to execute a protection algorithm for a Type of Service (ToS) value of a socket corresponding to an application, perform authentication of the application using a secure world (e.g., ARM TrustZone, Intel SGX, Apple Secure Enclave, etc.), dispose data of the application in one of security bands and general bands of transmit queues according to an authentication result of the application, and transmit data of the application through an activated band among the security bands and the general bands.

Aspects of the present disclosure describes a control method of a gateway, performed in a computing device including a processor, and a storage medium storing commands executable by the processor. The method may include an operation of executing a protection algorithm for a type of service (ToS) value of a socket corresponding to an application, an operation of performing authentication of the application using a secure world, an operation of disposing data of the application in one of security bands and general bands of transmit queues according to an authentication result of the application, and an operation of transmitting data of the application through an activated band among the security bands and the general bands.

Aspects of the present disclosure describe a vehicle system, the vehicle system including one or more sensors, a central controller controlling a vehicle, and a gateway connected between the one or more sensors and the central controller to control a flow of data within the vehicle. The gateway may include a processor and a storage medium storing commands executable by the processor. By executing the commands, the processor may be configured to execute a protection algorithm for a Type of Service (ToS) value of a socket corresponding to an application in a vehicle, perform authentication of the application using a secure world, dispose data of the application in one of security bands and general bands of transmit queues, depending on an authentication result of the application, and transmit data of the application to the central controller through an activated band among the security bands and the general bands.

Examples described herein may include a gateway device for a vehicle and/or a method for the gateway system to control data flow in a vehicle. The gateway device may comprise a processor and memory storing instructions that, when executed by the processor, cause the gateway device to perform various functions. Example functions include executing a protection algorithm to determine a Type of Service (ToS) value of a socket associated with an application (e.g., an application of the vehicle); authenticating, via a secure world associated with the processor and supporting a trusted execution environment, the application; based on a determination of whether the application is authenticated, insert data of the application into one of: a security band of transmit queues of the gateway device and a general band of the transmit queues of the gateway device; and transmitting the data of the application via the selected one of the security band and the general band.

In some examples, the gateway device may be configured to, based on the ToS value of the socket and a priority value of the socket associated with the application, transmit data of a non-malicious application to the security band and transmit data of a malicious application to the general band.

In some examples, the gateway device may be configured to execute the protection algorithm by, based on a determination that the application has set the ToS value of the socket to a ToS value associated with the security band, change the ToS value of the socket to a value associated with the general band, wherein the application has not been successfully authenticated in the trusted execution environment.

In some examples, the gateway device may be configured to transmit an electronic signature of the application to a trusted application located within the secure world and determine whether the application is non-malicious by the trusted application.

In some examples, the gateway device may be configured to transmit the electronic signature of the application by transmitting the electronic signature via a driver for communicating with the secure world and receiving an authentication result from the trusted application via the driver.

In some examples, the driver may be an open portable trusted execution environment (OP-TEE) driver that is configured to communicate with the trusted execution environment in a general world of the gateway device.

In some examples, the gateway device may be configured to change a priority value of the socket associated with the application to a priority value associated with the security band, based on a determination that the application is non-malicious and via the driver.

In some examples, the gateway device may be configured to activate the security band and block the general band based on a determination that the application is non-malicious and via the driver.

In some examples, the gateway device may be configured to transmit the data of the application by sequentially transmitting the data in the selected one of the security band and the general band externally via an Ethernet connection.

Examples described herein include a vehicle system comprising one or more sensors, a central controller controlling a vehicle, and a gateway device connected between the one or more sensors and the central controller. The gateway device may be configured to: execute a protection algorithm to determine a Type of Service (ToS) value of a socket associated with an application (e.g., an application of the vehicle); authenticate, via a secure world supporting a trusted execution environment of the gateway device, the application; based on a determination of whether the application is authenticated, insert data of the application into one of a security band of transmit queues of the gateway device and a general band of the transmit queues of the gateway device; and transmit the data of the application via the selected one of the security band and the general band.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1A illustrates an example configuration of a vehicle system;

FIG. 1B illustrates an example method for controlling the flow of data of a vehicle system;

FIG. 2 illustrates an example configuration of a vehicle system according to aspects of the present disclosure;

FIG. 3 illustrates an example method for controlling a flow of data of a vehicle system according to aspects of the present disclosure;

FIG. 4 illustrates an example ToS table for executing a protection algorithm according to aspects of the present disclosure;

FIG. 5 illustrates an example protection algorithm according to aspects of the present disclosure;

FIG. 6 illustrates an example authentication process of an application according to aspects of the present disclosure;

FIG. 7 is an example flowchart of a control method of a gateway according to aspects of the present disclosure;

FIG. 8 is a graph illustrating example data transmission speeds of UDP communication according to an example and a comparative example of the present disclosure;

FIG. 9 is a graph illustrating example data transmission speeds of TCP communication according to an example and a comparative example of the present disclosure; and

FIG. 10 is a block diagram of an example computing device that can fully or partially implement a vehicle system according to aspects of the present disclosure.

### DETAILED DESCRIPTION

Hereinafter, examples of the present disclosure will be described with reference to the drawings. The detailed descriptions that follow are provided to facilitate a comprehensive understanding of the methods, devices and/or systems described herein. However, examples of the present disclosure may be implemented in various ways, and thus the present disclosure is not limited to the examples described therein.

In describing the embodiments of the present disclosure, if it is determined that the detailed description of the known technology related to the present disclosure may unnecessarily obscure the subject matter of the present disclosure, the detailed description thereof will be omitted. In addition, terms to be described later are terms defined in consideration of functions in the present disclosure, which may vary according to the intention or custom of a user or operator. Therefore, the definition should be made based on the contents throughout this specification. The terminology used in the detailed description is only for describing the embodiments of the present disclosure and should in no way be limiting. Unless expressly used otherwise, singular forms of expression include plural forms.

In addition, throughout the specification, when a part is said to be ‘connected’ to another part, it is not only ‘directly connected,’ but also ‘indirectly connected’ with other components interposed therebetween.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry, for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic-purpose processor capable of performing the specific operation by executing software, or to a special-purpose computer structured through programming to perform the specific operation.

Described herein is a gateway device, in a vehicle, that securely manages data transmission from vehicle applications. The gateway may include a processor and memory that work together to run a protection algorithm and determine the Type of Service (ToS) value of each socket (a network communication endpoint) used by applications. The gateway may also include a secure world (e.g., a trusted execution environment isolated from normal processing of the processors of the gateway device) that authenticates whether an application is non-malicious or potentially malicious/harmful. Depending on the authentication result, the gateway classifies and inserts the application's data into either a "security band" or a "general band" within its transmit queues. The data is then sent out via the appropriate band, such as over an Ethernet connection, with security band data reserved for trusted/non-malicious applications and general band data for unverified or malicious sources.

The gateway device described herein may enhance security by monitoring if an application tries to falsely set its ToS value to gain access to the security band and correcting such attempts automatically. The gateway device may authenticate applications by sending a digital signature to a trusted application within the secure world, using a driver (such as an OP-TEE driver) for communication. If the application is verified as trustworthy, the system can adjust the socket’s priority, activate the security band, and optionally block the general band to isolate sensitive data streams. The gateway device described herein may be included in a vehicle system that includes sensors (e.g., radar, lidar, ultrasonic sensors, cameras, temperature sensors, oxygen sensors, wheel speed sensors, accelerometers, gyroscopes, etc.) and a central controller that controls the operations of the vehicle system. The gateway device may be positioned between the sensors and the central controller to ensure only sensor data from authenticated, non-malicious applications is prioritized for transmission to the central controller.

The one or more features described herein (e.g., features associated with a gateway receiving data from one or more sensors, executing a protection algorithm for a Type of Service (ToS) value of a socket corresponding to an application associated with the sensors, perform authentication of the application using a secure world, dispose data of the application in one of security bands and general bands, transmit data of the application through an activated band among the security bands and the general bands, etc.) may be associated with one or more operations of autonomous driving of a vehicle.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver, including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: a biometric information registration of a user other than an owner of a vehicle, one or more authentication features associated with the biometric information registration associated with granting vehicle control authority for one or more operations of autonomous driving of a vehicle, an autonomous driving classification, a selection of an autonomous driving level for a vehicle, etc.). Based on one or more features (e.g., features associated with a gateway receiving data from one or more sensors, executing a protection algorithm for a Type of Service (ToS) value of a socket corresponding to an application associated with the sensors, perform authentication of the application using a secure world, dispose data of the application in one of security bands and general bands, transmit data of the application through an activated band among the security bands and the general bands, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., a biometric information registration of a user other than an owner of a vehicle, one or more authentication features associated with the biometric information registration associated with granting vehicle control authority for one or more operations of autonomous driving of a vehicle, etc.) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of managing a battery of a vehicle) described herein.

Minimum risk maneuver (MRM) operation(s) may also be controlled, for example, based on one or more features (e.g., features associated with a gateway receiving data from one or more sensors, executing a protection algorithm for a Type of Service (ToS) value of a socket corresponding to an application associated with the sensors, perform authentication of the application using a secure world, dispose data of the application in one of security bands and general bands, transmit data of the application through an activated band among the security bands and the general bands, etc.).) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., e.g., features associated with a gateway receiving data from one or more sensors, executing a protection algorithm for a Type of Service (ToS) value of a socket corresponding to an application associated with the sensors, perform authentication of the application using a secure world, dispose data of the application in one of security bands and general bands, transmit data of the application through an activated band among the security bands and the general bands, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features associated with a gateway receiving data from one or more sensors, executing a protection algorithm for a Type of Service (ToS) value of a socket corresponding to an application associated with the sensors, perform authentication of the application using a secure world, dispose data of the application in one of security bands and general bands, transmit data of the application through an activated band among the security bands and the general bands, etc.) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features associated with a gateway receiving data from one or more sensors, executing a protection algorithm for a Type of Service (ToS) value of a socket corresponding to an application associated with the sensors, perform authentication of the application using a secure world, dispose data of the application in one of security bands and general bands, transmit data of the application through an activated band among the security bands and the general bands, etc.) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five seconds, 30 seconds, 1 minute, etc.). By changing the required user attentiveness, the driver may be required to look ahead more often (e.g., at least once in a threshold time period, such as five seconds, 30 seconds, 1 minute, etc.). By changing the autonomous driving level, one or more video contents may not be displayed on a display of the vehicle.

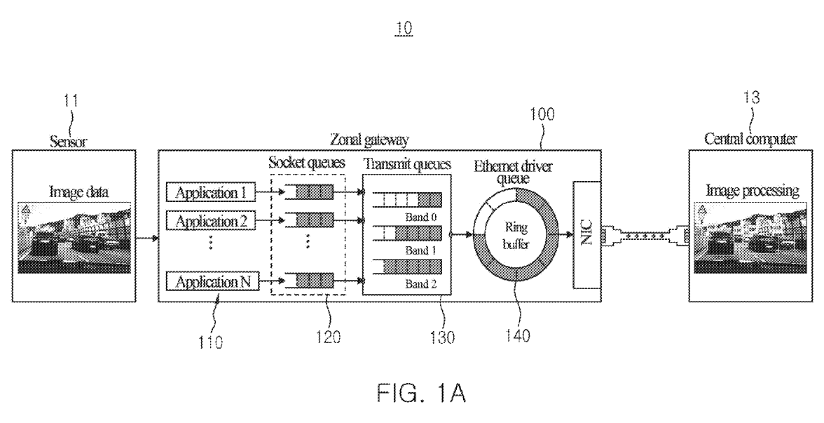

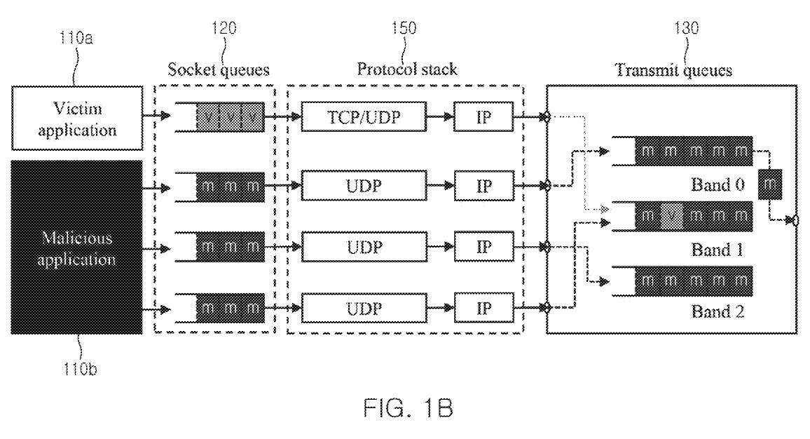

FIG. 1A illustrates an example configuration of a vehicle system, and FIG. 1B illustrates an example flow of data within the vehicle system illustrated in FIG. 1A. In the present disclosure, the “system” may include at least one device among a computing device, a network device, a controller, a vehicle device, a server device, and/or a cloud device, but is not limited thereto. For example, the system may include (or be configured with) one or more server devices. As another example, the system may include (or be configured with) one or more cloud devices. As another example, the system may operate with a server device and a cloud device.

Referring to FIGS. 1A and 1B, a vehicle system 10 according to the prior art includes a sensor 11, a central controller 13, and an apparatus for a gateway 100.

The sensor 11 may include an image sensor that acquires an image of the exterior or the interior of a vehicle. For example, the sensor 11 may capture image data and/or transmit the image data to the gateway 100 at regular intervals.

The central controller 13 may process data received from one or more sensors 11 via the gateway 100 and/or perform overall control of the vehicle. For example, the central controller 13 may perform object recognition tasks on image data acquired by the sensor 11 and received through the gateway 100.

The central controller 13 may receive data from the gateway 100 via Ethernet communication.

The gateway 100 may be connected between the sensor 11 and the central controller 13 to control a flow of data within the vehicle and/or between the sensor 11 and the central computer 13. The gateway 100 may receive sensor data from the sensor 11 and output processed data to the central controller 13.

The gateway 100 may control the flow of data by sequentially transmitting data of an in-vehicle application 110 to socket queues 120, transmit queues 130, and the Ethernet driver queue 140.

The socket queue 120 may include a socket and a queue corresponding to each application 110. Each socket may be assigned a priority value.

Data of the socket queue 120 is transmitted to the transmission queue 130 through a protocol stack 150.

The transmission queue 130 may include a plurality of bands in which data received from the socket queue 120 is disposed. The plurality of bands may have a priority for data transmission.

Data received from the socket queue 120 may be disposed in a band corresponding to the priority value assigned to each socket among the plurality of bands.

In the transmission queue 130, data of a band with a high priority may be sequentially transmitted to the Ethernet driver queue 140.

In an example illustrated in FIG. 1A, data disposed in the plurality of bands of the transmission queue 130 may be transmitted to the Ethernet driver queue 140 in order of Band 0, Band 1, and Band 2. For example, data disposed in Band 1 may be transmitted after all data disposed in Band 0 is transmitted, and/or data disposed in Band 2 may be transmitted after all data disposed in Bands 0 and 1 are transmitted.

Accordingly, as illustrated in FIG. 1B, when a malicious application 110b continues to dispose data packets (m) in Band 0, which has the highest priority, in the transmission queue 130, a problem may occur in which data transmission of a general application 110a may be greatly delayed or become impossible.

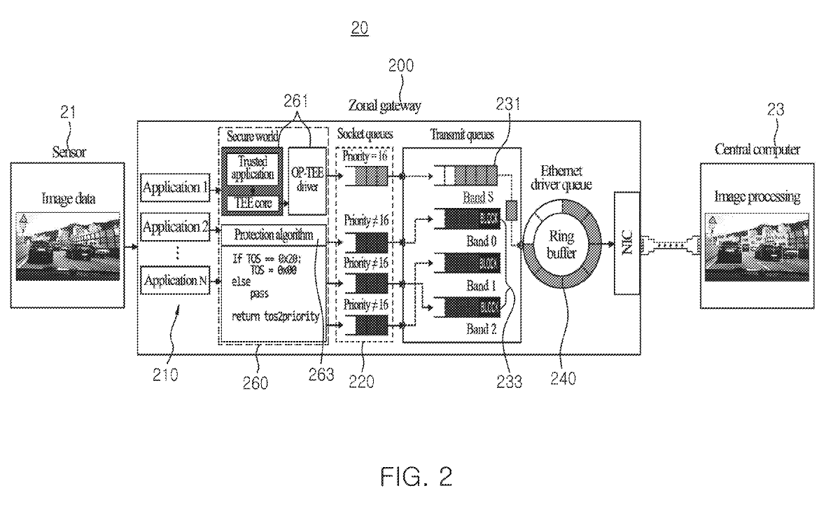

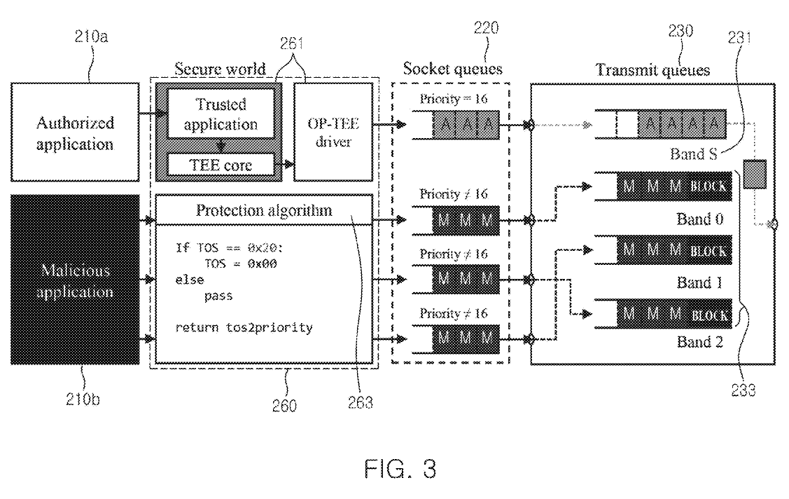

FIGS. 2 and 3 illustrate example configurations of a vehicle system according to aspects of the present disclosure.

A vehicle system 20 according to an embodiment of the present disclosure includes a sensor 21, a central controller 23, and/or a gateway 200. The gateway 200 may serve as a critical communication hub that manages data exchange between different electronic control units (ECUs)(e.g., the sensors 21, the central computer 23, etc.) and network domains. Vehicles may typically contain multiple in-vehicle networks, such as Controller Area Network (CAN), Media Oriented Systems Transport (MOST), Local Interconnect Network (LIN), FlexRay, Ethernet, etc., where each one of the networks may be optimized for specific functions like powertrain control, infotainment, or advanced driver-assistance systems (ADAS). A controller area network (CAN) may comprise a communication protocol designed for real-time data exchange between microcontrollers and devices within vehicles and industrial systems. CAN may allow multiple electronic control units to communicate with each other without the need for a host computer, making it useful for applications where reliable, high-speed communication is critical. A value-added network (VAN) and/or MOST may comprise a private network that provides businesses with secure, reliable communication channels for exchanging data and documents. VANs and/or MOSTs may offer services (e.g., data encryption, format translation, message routing, or tracking, etc.) to ensure that business documents (e.g., invoices, purchase orders, or shipping notices, etc.) may be transmitted efficiently and/or securely between trading partners. A local interconnect network (LIN) may comprise a low-cost serial communication protocol that may be used in automotive systems to connect electronic components (e.g., sensors, actuators, or control units, etc.). For example, for simplicity and/or cost-efficiency, LIN may manage functions that do not require high-speed data transfer (e.g., window controls, seat adjustments, lighting, or climate control, etc.). LIN may function on a single-master, multiple-slave architecture, where one master node may coordinate communication with multiple slave nodes.

The gateway 200 may ensure secure and efficient communication between these otherwise incompatible networks by routing, filtering, and translating messages. Additionally, the gateway 200 may implement cybersecurity measures to protect against external threats, particularly as vehicles become more connected via telematics and over-the-air (OTA) updates.

The sensor 21 may include an image sensor acquiring an image of an exterior or an interior of a vehicle. For example, the sensor 21 may transmit image data to the gateway 200 at regular intervals.

In addition to the image sensor, the vehicle system 20 may further include one or more sensors installed in the interior or exterior of the vehicle and detecting information related to a status and/or a driving situation of the vehicle(e.g., vehicle is parked, running, near another vehicle, etc.).

The one or more sensors 21 may further include at least one of an accelerator pedal position sensor (APS) which is linked to a driver's operation of an accelerator pedal, a brake pedal position sensor (BPS) which is linked to a driver's operation of a brake pedal, a wheel speed sensor detecting a wheel speed of a vehicle, a vehicle speed sensor detecting a driving speed of the vehicle, a slope sensor detecting an inclination of the vehicle or a gradient of a driving surface, a steering angle sensor (SAS) which is linked to an operation of a steering wheel, a temperature sensor detecting a temperature in the interior or exterior of the vehicle, an image sensor acquiring image data in the interior or exterior of the vehicle, and/or a distance sensor measuring a distance from the vehicle to an obstacle located in one direction.

The central controller 23 may process data received from one or more sensors 21 via the gateway 200 and perform overall control of the vehicle.

The central controller 23 may transmit and receive other components and signals included in the vehicle system 20. The central controller 23 may generate control signals for controlling other components of the vehicle system 20. The other components included in the vehicle system 20 may include, for example, at least one of a driving device, a braking device, a battery, a display, and a temperature control unit.

In some examples, the central controller 23 may perform object recognition tasks on image data acquired by the sensor 21 and received through the gateway 200.

The central controller 23 may receive data from the apparatus for a gateway 200 via Ethernet communication.

The gateway 200 may be connected between the sensor 21 and the central controller 23 to control a flow of data within the vehicle. The gateway 200 may receive sensor data from the sensor 21 and output processed data to the central controller 23.

As illustrated in FIG. 3, the gateway 200 may control the flow of data by sequentially transmitting data of in-vehicle applications 210a and 210b to socket queues 220, transmission queues 230, and Ethernet driver queues 240.

The socket queue 220 may include a socket and a queue corresponding to each application 210a and 210b. Each socket may be assigned a priority value.

The transmission queue 230 may include a plurality of bands 231 and 233 in which data received from the socket queue 220 may be disposed. The plurality of bands 231 and 233 may have a priority for data transmission.

The transmission queue 230 may include a security band 231 and a general band 233. For example, the security band 231 may be set to have a higher priority than the general band 233.

The security band 231 may be a band set so that only data of a normal application that has been authenticated in a secure world may be accessed. A Secure World may be a trusted execution environment (TEE) designed to isolate sensitive operations and data from the rest of the system. In a device or system that supports this architecture, such as the gateway 200, execution may be split into two domains: the Normal World (e.g., Bands 0, 1, and 2), where the main operating system and general applications run, and the Secure World (e.g., Band S), where trusted code executes independently with higher privileges and tighter security controls. This separation may allow the Secure World to perform critical tasks—such as secure boot, cryptographic operations, key management, and biometric authentication, without being exposed to potential threats in the Normal World. By isolating these functions, the Secure World may help protect against malware, rooting, and other attacks, ensuring a higher level of system integrity and data confidentiality, especially in security-sensitive applications like digital payments, enterprise authentication, and DRM enforcement.

In some examples, the security band 231 may include one band.

In some examples, the security band 231 may include a plurality of bands having a priority.

The general band 233 may be a band to which data of all applications may be accessed regardless of whether the application is authenticated.

Data received from the socket queue 220 may be disposed in a band corresponding to the priority value assigned to each socket among the plurality of bands.

In the transmission queue 230, data of a band with a high priority may be sequentially transmitted to the Ethernet driver queue 240. The transmission queue 230 may be set to transmit data of a security band 231 before data of a general band 233.

In an example illustrated in FIG. 2, data disposed in the transmission queue 230 may be transmitted to the Ethernet driver queue 240 in order of Band S, which may be a security band 231, and Band 0, Band 1, and Band 2, which may be general bands 233. For example, data disposed in Band 0 may be transmitted after all data disposed in Band S has been transmitted. Data disposed in Band 1 may be transmitted after all data disposed in Band S and Band 0 have been transmitted. Data disposed in Band 2 may be transmitted after all data disposed in Band S, Band 0, and Band 1 have been transmitted.

The Ethernet driver queue 240 may have a ring buffer form. Data may be transmitted externally through Ethernet communication from the Ethernet driver queue 240. For example, data may be sequentially transmitted from the Ethernet driver queue 240 to the central controller 23.

Referring to FIGS. 2 and 3 together, the gateway 200 may further include a security unit 260. The security unit 260 may include an authentication unit 261 and a protection algorithm execution unit 263.

The authentication unit 261 may perform authentication of the applications 210a and 210b using a secure world. As described above, the secure world may be an execution environment in which access is restricted from the normal world.

In an embodiment, the secure world may be a Trusted Execution Environment.

The authentication unit 261 may transmit an electronic signature of the application 210a or 210b to a trusted application located within the secure world, and authenticate whether the application is authorized and/or whether the application is malicious through a trusted application.

The electronic signature of the application 210a or 210b may be transmitted to the trusted application in a limited manner through a driver for communicating with the secure world.

In an embodiment, the driver may be an Open Portable Trusted Execution Environment (OP-TEE) driver for communicating with a trusted execution environment (TEE) in the general world.

When it is confirmed that the application 210a or 210b is authorized and/or not malicious (e.g., normal), the authentication unit 261 may change the priority value of a socket corresponding to the application 210a or 210b to a priority value corresponding to a security band.

Depending on the authentication result of the application 210a or 210b, data of the application 210a or 210b may be transmitted to one of the security bands 231 or general bands 233 of transmission queues 230.

For example, based on the ToS value and the priority value of the socket corresponding to the application 210a or 210b, data of the application 210 may be disposed in one of the security bands 231 or the general bands 233.

When it is confirmed that the application 210 is authenticated and/or not malicious, the authentication unit 261 may activate the security band 231 and block the general band 233.

The protection algorithm execution unit 263 may block access to the security band 231 through user authority (e.g., authentication of the user controlling the vehicle).

When an application sets a ToS value of a socket to a ToS value corresponding to the security band 231 in normal/user space (e.g., not secure space), the protection algorithm execution unit 263 may execute a protection algorithm that forcibly changes the ToS value of the socket corresponding to the application to a ToS value corresponding to the general band 233.

The gateway 200 may transmit data of a normal or authorized application 210a to a security band 231 and data of a malicious application 210b to a general band 233.

The gateway 200 may transmit data of an application 210a or 210b to an Ethernet driver queue 240 through an activated band among the security bands 231 and the general bands 233, and data may be sequentially transmitted from the Ethernet driver queue 240 to the central controller 23.

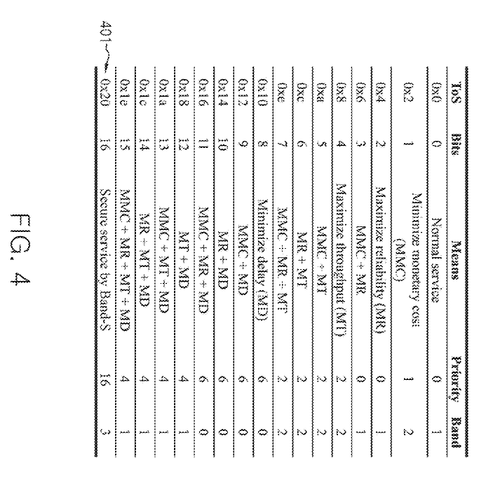

FIG. 4 illustrates a ToS table for executing a protection algorithm in a gateway 200 according to examples of the present disclosure. The ToS table may include information on a priority value that matches a ToS value of a socket.

The gateway 200 may transmit application data from an application to a security band 231 or a general band 233 according to the priority value of the socket of the application.

In an embodiment, a ToS 401 corresponding to a security band may be additionally set in the ToS table of the apparatus for a gateway 200.

For example, as illustrated in FIG. 4, the ToS value corresponding to the security band may be set to be 0x20 in the ToS table, and the priority value corresponding to the security band may be set to be 16.

According to the ToS table illustrated in FIG. 4, the gateway 200 may dispose data of an application, where a ToS value of a socket corresponding to the application is 0x20 or the priority value of the application is 16, in the security band of the transmission queue.

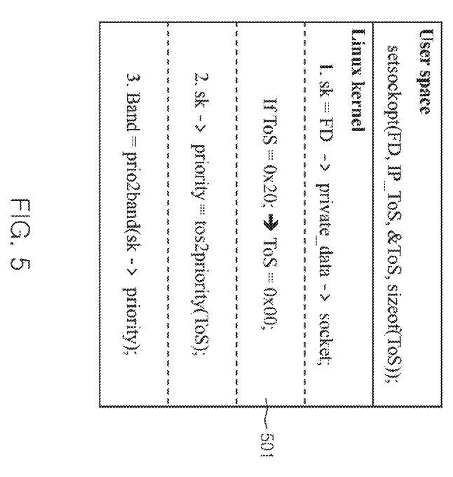

FIG. 5 illustrates an example protection algorithm executed in a gateway 200 according to examples of the present disclosure.

When an application sets a ToS value of a socket in user space to 0x20, a ToS value corresponding to a security band, the gateway 200 may forcibly change a ToS value of a socket to a ToS value corresponding to a general band by executing a protection algorithm 501.

In some examples, the gateway 200 may execute the protection algorithm 501 when an attack by a malicious application 210b is detected. An attack by a malicious application 210b may be, for example, an operation changing the ToS value of a socket of an application in user space.

The gateway 200 described in the present disclosure may block data of a malicious application 210b from accessing a security band 231 through a protection algorithm 501 based on a ToS value, thereby enhancing the security of internal communications of a vehicle.

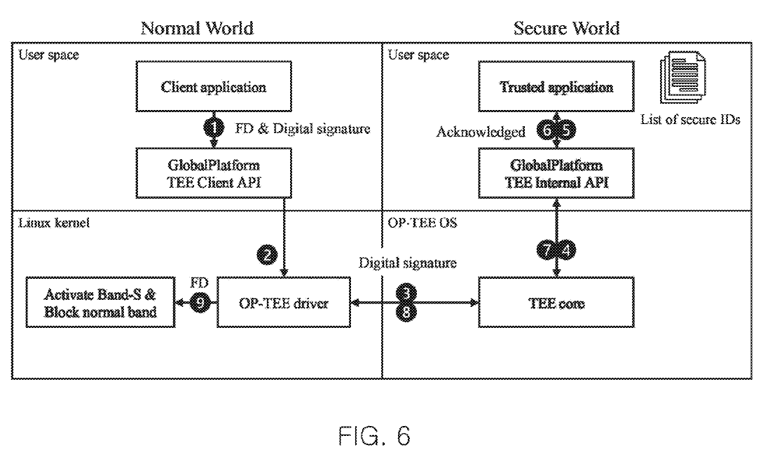

FIG. 6 illustrates an example authentication process of an application in an apparatus for a gateway 200 according to an embodiment of the present disclosure.

A data processing environment of the gateway 200 according to examples of the present disclosure may be divided into a normal world and a secure world. The secure world may be an execution environment in which access from the normal world is restricted. In some examples, the gateway 200 may operate within a trusted execution environment (TEE) that supports execution in multiple security domains. Specifically, the system may utilize a processor architecture (e.g., ARM TrustZone) that implements a Secure World and a Normal World. The Secure World may be configured to execute trusted code and manage sensitive operations, such as cryptographic key storage, authentication, and secure boot processes. It is isolated from the Normal World to prevent unauthorized access and to ensure the integrity and confidentiality of the trusted resources.

The Normal World may execute the primary operating system and general-purpose applications. Components operating in the Normal World may request services from the Secure World via defined communication channels (e.g., secure monitor calls or inter-process communication interfaces). In this manner, sensitive operations are offloaded to the Secure World, while the Normal World remains unaware of the internal implementation details, thereby reducing the attack surface and improving system security.

Data can only be transmitted and received between the general world and the secure world through a preset route.

In some examples, the secure world may be a trusted execution environment, and data may be transmitted and received between the general world and the secure world through an OP-TEE driver of the general world and a TEE core of the secure world.

As illustrated in FIG. 6, in a general or normal world, an application may transmit a File Descriptor (FD) and an electronic signature through the OP-TEE driver (1, 2 in FIG. 6).

The OP-TEE driver may transmit the electronic signature of the application to a trusted application through the TEE core within the secure world (3, 4, 5 in FIG. 6).

The trusted application may authenticate whether the application is normal within a secure world (e.g., authorized for the secure world or not malicious). An authentication result of the application by a trusted application may be transmitted to the OP-TEE driver within a general or normal world through the TEE core (6, 7, 8 in FIG. 6).

When it is confirmed that the application is normal(e.g., authorized for the secure world or not malicious), depending on the authentication result of the application by the trusted application, a priority value of a socket corresponding to the application may be changed by the OP-TEE driver to a priority value corresponding to a security band (for example, priority value 16).

When it is confirmed that the application is normal (e.g., authorized for the secure world or not malicious), depending on the authentication result of the application by the trusted application, the OP-TEE driver may activate the security band, and/or a general band may be blocked (9 in FIG. 6).

Data disposed in the activated band may be sequentially transmitted to an Ethernet driver queue (e.g., the Ethernet driver queue 240). When the security band is activated and the general band is blocked, only data packets disposed in the security band may be transmitted to the Ethernet driver queue.

In some examples, when both the security band and the general band are activated, data placed in the security band and the general band may both be sequentially transmitted to the Ethernet driver queue. When both the security band and the general band are activated, data packets disposed in the general band may be transmitted to the Ethernet driver queue only after all data packets disposed in the security band with the highest priority have been transmitted, or only when there are no data packets disposed in the security band.

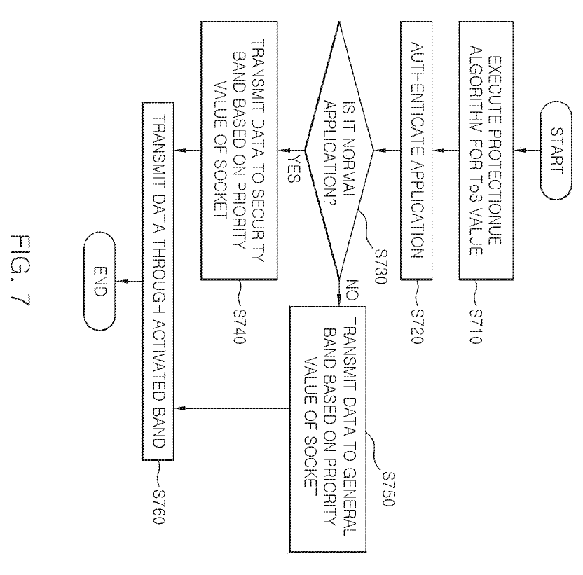

FIG. 7 is a flowchart of an example control method of a gateway according to aspects of the present disclosure. For convenience, FIG. 7 is described by way of an example in which a gateway described herein performs the steps. One, some, or all steps of the example method of FIG. 7, or portions thereof, may be performed by one or more other devices. One or more steps of the example method of FIG. 7 may be omitted, performed in other orders, and/or otherwise modified, and/or one or more additional steps may be added.

Referring to FIG. 7, the control method of a gateway may include an operation (S710) of executing a protection algorithm for a ToS value and an operation (S720) of performing authentication of an application.

When an application sets a ToS value of a socket to a ToS value corresponding to a security band in user space, the operation (S710) of executing a protection algorithm for a ToS value may include an operation of changing the ToS value of the socket corresponding to the application to a ToS value corresponding to a general band.

Based on the ToS value and the priority value of the socket corresponding to the application, data of a normal application (e.g., authenticated and/or not malicious application) may be transmitted to the security band, and data of a malicious application may be transmitted to the general band.

The operation (S720) of performing authentication of an application may include an operation of authenticating whether the application is normal (e.g., not malicious or previous indicated as a secure application) by a trusted application located within a secure world.

The operation (S720) of performing authentication of an application may include further include an operation of transmitting an electronic signature of the application through a driver for communicating with a secure world, an operation of transmitting an electronic signature of the application from a driver to a trusted application, and an operation of transmitting an authentication result from the trusted application through the driver.

In some examples, the secure world may be a trusted execution environment, and the driver may be an open portable trusted execution environment (OP-TEE) for communicating with the trusted execution environment in a general or normal world.

The control method of a gateway may further include an operation of changing the priority value of the socket corresponding to the application to a priority value corresponding to the security band when it is confirmed that the application is normal (e.g., authenticated or not malicious), depending on the authentication result of the application of S720.

Depending on the authentication result of the application of S720, when it is confirmed that it is a normal application, data of the application may be transmitted to a security band based on the priority value of the socket (S730, S740).

Depending on the authentication result of the application of S720, when it is confirmed that it is not a normal application (e.g., authenticated or malicious), data of the application may be transmitted to a general band based on the priority value of the socket (S730, S750).

The control method of the gateway may further include an operation of activating the security band and blocking the general band when it is confirmed that the application is normal, depending on the authentication result of the application of S720.

Next, data of the application may be transmitted through the activated band (S760). For example, the data of the application disposed in the activated band of the transmission queue may be transmitted to the Ethernet driver queue (e.g., Ethernet driver queue 240) and transmitted to a central controller through Ethernet communication.

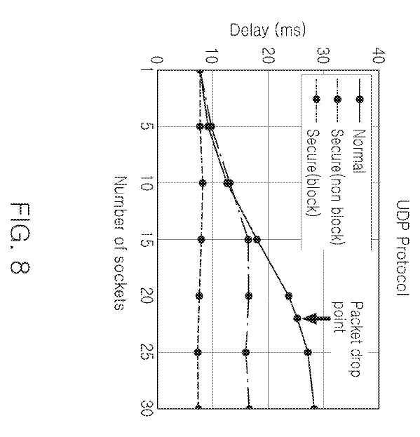

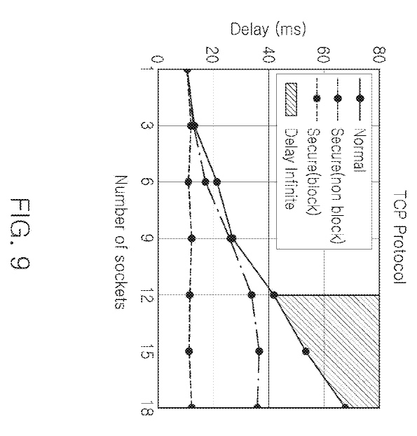

FIGS. 8 and 9 are graphs illustrating data transmission speeds according to an example (Secure) and a comparative example (Normal) of the present disclosure.

FIG. 8 illustrates data transmission speeds of UDP communication, and FIG. 9 illustrates a comparison of data transmission speeds of TCP communication. User Datagram Protocol (UDP) may comprise a communication protocol that may be used in networking for transmitting data over the Internet. For example, UDP may be connectionless and may not require a dedicated connection between a sender and a receiver. UDP may send data in small packets called datagrams without checking for errors or ensuring delivery order. UDP may be useful in applications where speed may be important and occasional data loss may be acceptable. Transmission Control Protocol (TCP) is a connection-oriented protocol used for reliable data transmission over IP networks. TCP establishes a connection between endpoints before data transfer and ensures that data packets are delivered in order and without errors through mechanisms such as acknowledgments, retransmissions, and flow control. It is widely used in applications requiring reliable communication.

In FIGS. 8 and 9, a normal graph represents a delay time when a control method of a gateway according to an embodiment of the present disclosure is not applied, and a normal application and a malicious application compete. A Secure (block) graph represents a delay time in a state in which only data of a normal application may be accessed through a security band, and only the secure band is activated and the normal band is blocked, according to a control method of a gateway, according to examples of the present disclosure. The Secure (non-block) graph represents the delay time in a state in which only data of a normal application may be accessed through the security band and both the security band and a general band are open, according to a control method of a gateway, according to other examples of the present disclosure.

Referring to FIGS. 8 and 9, it was confirmed that the delay time was shorter in the order of Secure (block), Secure (non-block), and Normal, and as a result, the data transmission speed was improved.

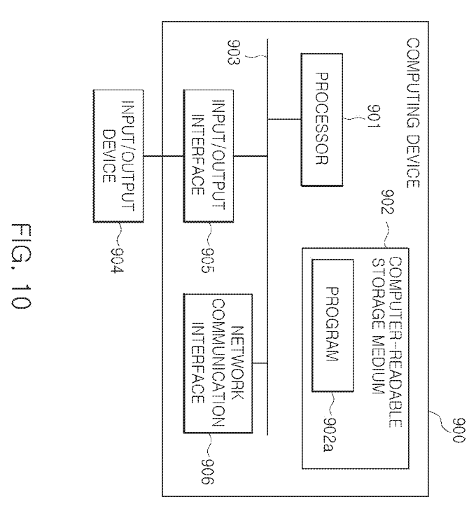

FIG. 10 is a block diagram of an example computing device 900 that may fully or partially implement a vehicle system 20 according to examples of the present disclosure, and may include all or part of the vehicle system 20 illustrated in FIG. 2, in particular, the gateway device 200.

As illustrated in FIG. 10, the computing device 900 includes at least one processor 901, a computer-readable storage medium 902, and a communication bus 903.

The processor 901 may cause the computing device 800 to operate according to the above-described exemplary embodiments. For example, the processor 901 may execute one or more programs store in the computer-readable storage medium 902. The one or more programs may include one or more computer executable instructions, wherein, when executed by the processor 901, the computer-readable executable instructions may be configured to cause the computing device 900 to perform operations according to an exemplary embodiment.

The computer-readable storage medium 902 is configured to store computer-executable instructions or program code, program data, and/or other suitable forms of information. A program 902a stored on the computer-readable storage medium 902 includes a set of instructions executable by the processor 901. In an embodiment, the computer-readable storage medium 902 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 900 and store desired information, or suitable combinations thereof.

The communication bus 903 interconnects various other components of the computing device 900, including the processor 901 and the computer-readable storage medium 902.

The computing device 900 may also include one or more input/output interfaces 905 and one or more network communication interfaces 906 providing an interface for one or more input/output devices 904. The input/output interface 905 and the network communication interface 906 are connected to the communication bus 903.

The network communication interface 906 is an interface for communication within the vehicle or an interface for communication between the vehicle and other devices outside the vehicle, and may include, for example, a Controller Area Network (CAN), a Media Oriented Systems Transport (MOST) network, a Local Interconnect Network (LIN), and/or X-by-Wire (FlexRay), Wi-Fi, Bluetooth, NFC, RFID, etc. The network may be either a cellular network, such as a global system for mobile communications (GSM), enhanced data rates for GSM evolution (EDGE), a general packet radio service (GPRS), a code division multiple access (CDMA), a time division CDMA(TD-CDMA), a universal mobile telecommunications system (UMTS), a long term evolution (LTE), or another cellular network.

The input/output device 904 may be connected to other components of the computing device 900 through the input/output interface 905. The exemplary input/output device 904 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card. The exemplary input/output device 904 may be included inside the computing device 900 as a component constituting the computing device 900, or may be connected to the computing device 900 as a separate device, distinct from the computing device 900.

Meanwhile, embodiments of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium, such as hard disks, floppy disks and magnetic tapes, an optical recording medium, such as CD-ROMs and DVDs, and program instructions, such as ROM, RAM, and a flash memory and perform the same. Examples of the program may include not only machine language codes generated by a compiler, but also high-level language codes that may be executed by a computer using an interpreter.

As set forth above, according to the present disclosure, an apparatus for a gateway, a control method of the gateway, and a vehicle system that can enhance the security and stability of an Ethernet-based in-vehicle communication, may be provided.

According to the present disclosure, an apparatus for a gateway, a control method of the gateway, and a vehicle system that can prevent a malicious application from accessing the ToS value of a socket and interfering with other data transmission, may be provided.

According to the present disclosure, an apparatus for a gateway, a control method of the gateway, and a vehicle system that can control a flow of data so that only authenticated applications may transmit data in a limitedly accessible security environment, may be provided.

While various examples have been illustrated and described above, it will be apparent to those skilled in the art that modifications and variations could be made without departing from the scope of the present disclosure as defined by the appended claims.

What is claimed is:

1. A gateway device for a vehicle, comprising:
a processor; and
memory storing instructions that, when executed by the processor, cause the gateway device to:
execute a protection algorithm to determine a Type of Service (ToS) value of a socket associated with an application of the vehicle;
authenticate, via a secure world associated with the processor and supporting a trusted execution environment, the application;
based on a determination of whether the application is authenticated, insert data of the application into one of:
a security band of transmit queues of the gateway device; and
a general band of the transmit queues of the gateway device; and
transmit the data of the application via the selected one of the security band and the general band.

2. The gateway device of claim 1, wherein the instructions, when executed by the processor, further cause the gateway device to:
based on the ToS value of the socket and a priority value of the socket associated with the application:
transmit data of a non-malicious application to the security band; and
transmit data of a malicious application to the general band.

3. The gateway device of claim 1, wherein the instructions, when executed by the processor, further cause the gateway device to execute the protection algorithm by:
based on a determination that the application has set the ToS value of the socket to a ToS value associated with the security band, changing the ToS value of the socket to a value associated with the general band, wherein the application has not been successfully authenticated in the trusted execution environment.

4. The gateway device of claim 1, wherein the instructions, when executed by the processor, further cause the gateway device to authenticate the application by:
transmitting an electronic signature of the application to a trusted application located within the secure world; and
determining whether the application is non-malicious by the trusted application.

5. The gateway device of claim 4, wherein the instructions, when executed by the processor, further cause the gateway device to transmit the electronic signature of the application by:
transmitting the electronic signature via a driver for communicating with the secure world; and
receiving an authentication result from the trusted application via the driver.

6. The gateway device of claim 5, wherein the driver is an open portable trusted execution environment (OP-TEE) driver that is configured to communicate with the trusted execution environment in a general world of the gateway device.

7. The gateway device of claim 5, wherein the instructions, when executed by the processor, further cause the gateway device to:
based on a determination that the application is non-malicious and via the driver, change a priority value of the socket associated with the application to a priority value associated with the security band.

8. The gateway device of claim 5, wherein the instructions, when executed by the processor, further cause the gateway device to:
based on a determination that the application is non-malicious and via the driver, activate the security band and block the general band.

9. The gateway device of claim 1, wherein the instructions, when executed by the processor, further cause the gateway device to transmit the data of the application by:
sequentially transmitting the data in the selected one of the security band and the general band externally via an Ethernet connection.

10. A method performed by a gateway device in a vehicle, the method comprising:
executing, by a processor circuit of the gateway device, a protection algorithm to determine a Type of Service (ToS) value of a socket associated with an application of the vehicle;
authenticating, via a secure world hosted by the gateway device and supporting a trusted execution environment, the application;
based on a determination of whether the application is authenticated, inserting data of the application into one of:
a security band of transmit queues of the gateway device; and
a general band of the transmit queues of the gateway device; and
transmitting the data of the application via the selected one of the security band and the general band.

11. The method of claim 10, further comprising:
based on the ToS value of the socket and a priority value of the socket associated with the application:
transmitting data of a non-malicious application to the security band; and
transmitting data of a malicious application to the general band.

12. The method of claim 10, wherein the executing the protection algorithm comprises:
based on a determination that the application has set the ToS value of the socket to a ToS value associated with the security band, changing the ToS value of the socket to a value associated with the general band, wherein the application has not been successfully authenticated in the trusted execution environment.

13. The method of claim 10, wherein the authenticating the application comprises:
transmitting an electronic signature of the application to a trusted application located within the secure world; and
authenticating whether the application is non-malicious by the trusted application.

14. The method of claim 13, wherein the transmitting the electronic signature of the application comprises:
transmitting the electronic signature via a driver for communicating with the secure world; and
receiving an authentication result from the trusted application via the driver.

15. The method of claim 14, wherein the driver is an open portable trusted execution environment (OP-TEE) driver that is configured to communicate with the trusted execution environment in a general world of the gateway device.

16. The method of claim 14, further comprising:
based on a determination that the application is non-malicious and via the driver, changing a priority value of the socket associated with the application to a priority value associated with the security band.

17. The method of claim 14, further comprising:
based on a determination that the application is non-malicious and via the driver, activating the security band and blocking the general band.

18. The method of claim 10, wherein the transmitting the data of the application comprises sequentially transmitting the data in the selected one of the security band and the general band externally via an Ethernet connection.

19. A vehicle system for a vehicle, the vehicle system comprising:
one or more sensors;
a central controller controlling the vehicle; and
a gateway device connected between the one or more sensors and the central controller,
wherein the gateway device is configured to:
execute a protection algorithm to determine a Type of Service (ToS) value of a socket associated with an application of the vehicle;
authenticate, via a secure world supporting a trusted execution environment of the gateway device, the application;
based on a determination of whether the application is authenticated, insert data of the application into one of:
a security band of transmit queues of the gateway device; and
a general band of the transmit queues of the gateway device; and
transmit the data of the application via the selected one of the security band and the general band.

20. The vehicle system of claim 19, wherein the gateway device is further configured to:
based on the ToS value and a priority value of the socket associated with the application, transmit data of a non-malicious application to the security band and data of a malicious application to the general band.
